(19) United States
(12) Patent Application Publication
(10) Pub. No.: US 2026/0292481 A1
(43) Pub. Date: Sep. 24, 2026

(54) EARLY USER EQUIPMENT CAPABILITY INDICATION

(71) Applicant: Nokia Technologies Oy, Espoo (FI)

(72) Inventors: Tero HENTTONEN, Espoo (FI); Cássio Barboza RIBEIRO, Espoo (FI); Juha Sakari KORHONEN, Espoo (FI); Navin HATHIRAMANI, Dallas, TX (US); Zexian LI, Espoo (FI); Frank FREDERIKSEN, Aalborg (DK); Luis Guilherme UZEDA GARCIA, Massy (FR)

(21) Appl. No.: 19/472,390

(22) PCT Filed: Mar. 8, 2024
(86) PCT No.: PCT/IB2024/052266

§ 371 Date: Oct. 3, 2025

Related U.S. Application Data
(60) Provisional application No. 63/461,083, filed on Apr. 21, 2023.

(51) Int. Cl. H04W 8/24; H04W 74/0833

(52) U.S. Cl. CPC H04W 8/24; H04W 74/0833

(57) ABSTRACT

Systems, methods, apparatuses, and computer program products for early user equipment (UE) capability indication. A method may include receiving an indication from a network element that early capability indication is allowed. The method may also include transmitting, to the network element, at least one message indicating at least one set of user equipment capabilities.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for early user equipment (UE) capability indication.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, fifth generation (5G) radio access technology or NR access technology, and/or 5G-Advanced. 5G wireless systems refer to the next generation (NG) of radio systems and network architecture. 5G network technology is mostly based on NR technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include receiving an indication from a network element that early capability indication is allowed. The method may also include transmitting, to the network element, at least one message indicating at least one set of user equipment capabilities.

Other example embodiments may be directed to an apparatus. The apparatus may include at least one processor and at least one memory storing instructions that, when executed by the at least one processor, cause the apparatus at least to receive an indication from a network element that early capability indication is allowed. The apparatus may also be caused to transmit, to the network element, at least one message indicating at least one set of user equipment capabilities.

Other example embodiments may be directed to an apparatus. The apparatus may include means for receiving an indication from a network element that early capability indication is allowed. The apparatus may also include means for transmitting, to the network element, at least one message indicating at least one set of user equipment capabilities.

In accordance with other example embodiments, a non-transitory computer readable medium may be encoded with instructions that may, when executed in hardware, perform a method. The method may include receiving an indication from a network element that early capability indication is allowed. The method may also include transmitting, to the network element, at least one message indicating at least one set of user equipment capabilities.

Other example embodiments may be directed to a computer program product that performs a method. The method may include receiving an indication from a network element that early capability indication is allowed. The method may also include transmitting, to the network element, at least one message indicating at least one set of user equipment capabilities.

Other example embodiments may be directed to an apparatus that may include circuitry configured to receive an indication from a network element that early capability indication is allowed. The apparatus may also include circuitry configured to transmit, to the network element, at least one message indicating at least one set of user equipment capabilities.

Some example embodiments may be directed to a method. The method may include transmitting, to a user equipment, an indication that early capability indication is allowed. The method may also include receiving, in response to the indication, at least one message indicating at least one set of user equipment capabilities.

Other example embodiments may be directed to an apparatus. The apparatus may include at least one processor and at least one memory storing instructions that, when executed by the at least one processor, cause the apparatus at least to transmit, to a user equipment, an indication that early capability indication is allowed. The apparatus may also be caused to receive, in response to the indication, at least one message indicating at least one set of user equipment capabilities.

Other example embodiments may be directed to an apparatus. The apparatus may include means for transmitting, to a user equipment, an indication that early capability indication is allowed. The apparatus may also include means for receiving, in response to the indication, at least one message indicating at least one set of user equipment capabilities.

In accordance with other example embodiments, a non-transitory computer readable medium may be encoded with instructions that may, when executed in hardware, perform a method. The method may include transmitting, to a user equipment, an indication that early capability indication is allowed. The method may also include receiving, in response to the indication, at least one message indicating at least one set of user equipment capabilities.

Other example embodiments may be directed to a computer program product that performs a method. The method may include transmitting, to a user equipment, an indication that early capability indication is allowed. The method may also include receiving, in response to the indication, at least one message indicating at least one set of user equipment capabilities.

Other example embodiments may be directed to an apparatus that may include circuitry configured to transmit, to a user equipment, an indication that early capability indication is allowed. The apparatus may also include circuitry configured to receive, in response to the indication, at least one message indicating at least one set of user equipment capabilities.

### BRIEF DESCRIPTION OF THE DRAWINGS

For proper understanding of example embodiments, reference should be made to the accompanying drawings, wherein:

FIG. 1 illustrates an example signal diagram, according to certain example embodiments.

FIG. 2 illustrates another example signal diagram, according to certain example embodiments.

FIG. 3 illustrates an example flow diagram of a method, according to certain example embodiments.

FIG. 4 illustrates an example flow diagram of another method, according to certain example embodiments.

FIG. 5 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for early user equipment (UE) capability indication.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

In communications, UEs may connect to a network (e.g., gNB) by performing random access, sending a radio resource control (RRC) connection request to the network, and receiving basic RRC configuration from the network in response to the request. This connection process enables the network to acquire basic UE identification (i.e., international mobile subscriber identity (IMSI) or serving temporary mobile subscriber identity (S-TMSI)), which may be used to determine whether the UE has already been registered to the network, or whether the UE requires an additional non-access stratum (NAS) registration process. During the connection procedure, UE capabilities may be unknown to the network since the network only identifies the UE as part of the connection setup. Thus, message sizes and timings may mostly be fixed and require the network to assume that the UE only supports basic mandatory capabilities, which may restrict the possible configurations. At the completion of the connection setup procedure from IDLE, the UE may provide a NAS message towards the access and mobility management function (AMF) to setup the connectivity towards core network (CN). Once that is processed, the AMF indicates the UE capabilities to the radio access network (RAN), and the gNB may configure the UE with more advanced configurations.

Since UE capabilities may be unknown to the network at the connection setup, the network may need to wait until the AMF indicates the UE capabilities, which may cause a delay in connection procedures (e.g., due to only having access to basic configurations), and create inefficient transmissions (e.g., due to the network not being able to schedule the UE with advanced mechanisms including, for example, multiple input multiple output (MIMO) transmission/reception). Since the 5G network may use centralized unit-distributed unit (CU-DU) split, many configurations may need to be provided by the DU, which creates additional network delays since only the CU has connectivity to the AMF but CU needs to request part of the UE configuration from DU and only then transmit the configuration to the UE. As a result, all of these delays may reduce the UE and system performance.

With a diverse UE ecosystem, early identification of UE capabilities may be needed to avoid having initial access performance dictated by the worst case scenario of supported UEs. For example, the initial RRC message size may be limited to 48 or 64 bits in all cases for 5G due to extreme coverage requirements and the network not knowing anything about the UE capabilities. Further, considering that some UEs may have relatively short connections (e.g., for small data transmissions and short connections), the exchange of UE capabilities may only be available to the network after the needed communication exchange has taken place.

In view of the drawbacks and challenges described above, certain example embodiments may provide an early UE capability indication using a combination of UE capability sets. In some example embodiments, each UE capability set may include one or more UE capabilities, and there may be one or more such capability sets. The UE may indicate to the network its supported capability sets via Msg1 (i.e., a preamble), Msg3 (i.e., an RRC connection request), and/or Msg5 (i.e., an RRC connection setup complete). However, in other example embodiments, messages other than Msg1, Msg3, and Msg5 may be used to indicate UE capability information to the network. In further example embodiments, the UE capability information (i.e., UE capability set(s)) may be indicated to the network via a combination of messages (i.e., combination of Msg1, Msg3, and Msg5), and such combination may be based on a hierarchical manner. Additionally, the indication may be based on a network request for the capabilities, which could be done via common (e.g., system information) or dedicated signaling (e.g., via paging or as part of previous RRC configuration and stored while UE is not in CONNECTED mode). For example, paging may trigger the UE to use a specific Msg1 format for early UE capability indication, Msg2 may request the UE to indicate early capabilities in Msg3 and/or Msg5, or Msg4 may request the UE to indicate early capabilities in Msg5. As another example, UE may choose Msg1 based on network system information to indicate it supports early capabilities, then indicate the early capabilities in Msg3 and/or Msg5.

In certain example embodiments, each capability set may be configured. The configuration of each capability set may be, for example, predefined in the specification in which case all the UEs may indicate the same capabilities with the same capability index. In other example embodiments, the configuration of each capability set may be indicated via, for example, system information. In further example embodiments, the configuration of each capability set may be provided to the UE via dedicated signaling where the network is able to change the meaning of the capabilities in a per-UE or per-cell manner. The network may also include a bitmap in the system information indicating which capabilities or capability sets the network is interested to know so that the UE needs to inform network only on the capabilities or capability sets that the network wishes to know about. By informing the UE which capabilities or capability sets are desired by the network, it may be possible to allow legacy compatibility wherein the meaning of the bitmap changes over time, but the UE may know from the bits in the bitmap or the size of the bitmap, which interpretation to use. For instance, bits may indicate additional interpretations including, for example, for a bitmap of 8 bits, bits 1-4 may be defined in one specification release while others are left undefined. Further, the meaning of bits 5-8 may then be specified for a later release, while UEs only supporting bits 1-4 may ignore bits 5-8.

According to other example embodiments, the network may indicate to the UE the UE capability sets to be communicated per registration area during the registration procedure. Since each registration area may support different slices and devices with different capabilities, the network may configure the UE to report the support of these additional capabilities in such cases.

In certain example embodiments, certain basic features or feature groups may be assigned to a UE capability set. For example, a capability set (e.g., UE capability set) may be a combination of some basic capabilities, denote with Capability 0, Capability 1, . . . , Capability M-1, where M is the number of capabilities in the set. The capabilities within the set may either be predefined in the specification (e.g., common to all UEs) or signaled from the network to the UE (may be UE-or cell-specific). Additionally, a capability set may be a combination of all the capabilities in another capability set and additional basic capabilities, for example, so that the capability set 2 contains the whole of capability set 1 and also some additional capabilities. There may be one or more such capability sets, and the UE may indicate which of them it supports (e.g., via a bitmap in uplink (UL) signaling, or using an identifier that corresponds to a certain capability set).

For instance, in certain example embodiments, a combination of capability sets may include Capability i, Capability j, . . . , Capability k, so that these are the capabilities contained in all of the capability sets. The support for this capability combination may then be indicated by a 1-bit indication.

In other example embodiments, the capability sets may correspond to allowed sets. For instance, the allowed sets may be those that the network indicate (e.g., via dedicated signaling, common/SI signaling) are allowed to be indicated. The indication by the network may explicitly indicate the combinations that are allowed, or implicitly indicating some other information that the UE may use to infer which combinations are allowed. Additionally, the capability set indications may be used to indicate that only UEs supporting certain capabilities may be allowed to access the cell (e.g., UEs not supporting the indicated capability set(s) or capabilities within a capability set may not camp on the cell). In further example embodiments, the capability sets may be incremental capability sets where the gNB may provide a basic capability as part of “set 1”, while “set 2” may be constructed such that it may cover the capability of set 1 and the additional capabilities. With this approach, the UE's indication of capability may be reduced into a numerical value indicating which level of the incremental capability the UE supports.

According to certain example embodiments, if the indication of UE capabilities is not predefined in the specification but can be configured for the UE by the network, the used indication may differ per UE to avoid spoofing of UE capabilities via malicious users. For example, there may be a man-in-the-middle (MitM) denial of service (DoS) attack by telling the network that the UE supports different capabilities than it actually does, which may result in the UE not being able to receive RRC responses.

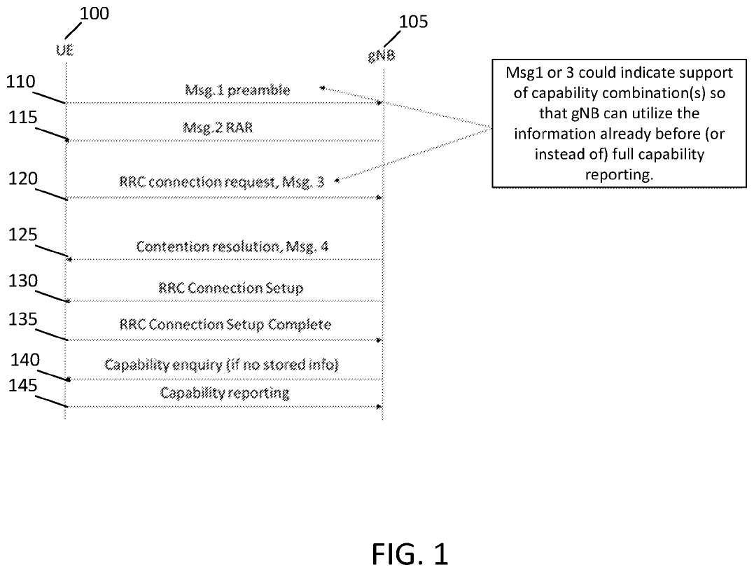

FIG. 1 illustrates an example signal diagram of message usage of early UE capability information, according to certain example embodiments. As illustrated in FIG. 1, Msg1 or Msg3 may indicate support of capabilities so that the network (e.g., gNB) may utilize the information before (or instead of) full capability reporting. At 110, the UE 100 may transmit Msg1 (preamble) to the gNB 105. In certain example embodiments, the transmission of Msg1 by the UE 100 may occur when the UE 100 starts RRC connection setup with the gNB 105.

In certain example embodiments, the early capability indication via Msg1 may be useful for Msg2/3 scheduling since the network may not need to always assume a limited capability for reception/transmission (RX/TX), but may use, for example, a better modulation coding scheme (MCS) or some advanced PHY features. The Msg1 may also be comprehended by the DU, which may mean that the UE capability information is immediately known at reception, not requiring a message towards the CU. Each capability indication may be associated with a set of physical random access channel (PRACH) resources. Additionally, the network may use a specific Msg2/Msg4 content to request the UE 100 to indicate specific other capabilities in Msg3/5. The specific other capabilities in Msg3/5 may be useful, for example, in case Msg1 only indicates that the UE 100 supports such early indication, but the actual information cannot fit within Msg1 content (e.g., if the preamble partitioning is sufficient to only indicate some basic scheduling enhancements for Msg2/3). This approach may be beneficial for indicating up to a few capability sets, since this may allow the ability to provide information of UE capability (at a rough level) without causing extensive fragmentation of the overall set of available preambles.

Returning to FIG. 1, at 115, the gNB 105 may transmit Msg2 to the UE 100, wherein Msg2 may include a random access response (RAR). At 120, in response to the reception of Msg2, the UE 100 may transmit Msg3 (RRC connection request) to the gNB 105 to connect to the network. At 125, in response to Msg3, the gNB 105 may transmit Msg4 (contention resolution) to the UE 100. At 130, the gNB 105 may initiate an RRC connection setup with the UE 100, and, at 135, the UE 100 may transmit Msg5 to the gNB 105 indicating that the RRC connection setup is complete. At 140, the gNB 105 may transmit a capability inquiry to the UE 100 when there is no stored information. In response, at 145, the UE 100 may transmit a capability reporting to the gNB 105.

According to certain example embodiments, the capability information (i.e., capability set(s)) received from Msg1/3 may include at least one or a combination of support of frequency range 2 (FR2), support of specific physical uplink control channel/physical uplink shared channel (PUCCH/PUSCH), and/or support of enhanced UE capability indication. The support of FR2 carrier may be indicated when there is an initial access on frequency range 1 (FR1). For instance, the network may know that the UE may be configured with a specific carrier, with optionally meaning that the carrier signal quality may be good enough to be configured. In some example embodiments, the support of the specific PUCCH/PUSCH configurations may allow the network to use more flexible scheduling for UL responses, and the support of enhanced UE capability indication may indicate that the UE supports additional early capability indication in later messages (e.g., Msg3/5).

In certain example embodiments, the UE indicating its capability in Msg3/5 may have several alternatives. For instance, in one example embodiment, N capability sets are defined, and UE indicates a bitmap of N bits such that the n:th bit equal to 1 means that UE supports the n:th capability set. In a special case, each capability set includes just a single capability and then each bit in the bitmap corresponds to a capability. In another example embodiment, N capability sets are defined, and UE signals the identifier(s) (IDs) of the capability set(s) that it supports. The selection between indication through bitmap or ID(s) may depend on the construction of the capability sets and may be flexibly controlled by gNB. If the capability sets are defined hierarchically i.e., all the capabilities of set j are included in set j+1, the ID signaling is more efficient because a bitmap would carry redundant information.

According to certain example embodiments, Msg5 transmitted at 135 may provide an indication of the completion of the RRC connection setup between the UE 100 and the gNB 105. Knowing at least partly the UE capabilities at this stage may allow the network to immediately create a configuration that allows better user plane (UP) connectivity before full capability signaling. This may speed up the connection process, or at least allow for better scheduling of a first RRCReconfiguration that sets up the DRBs.

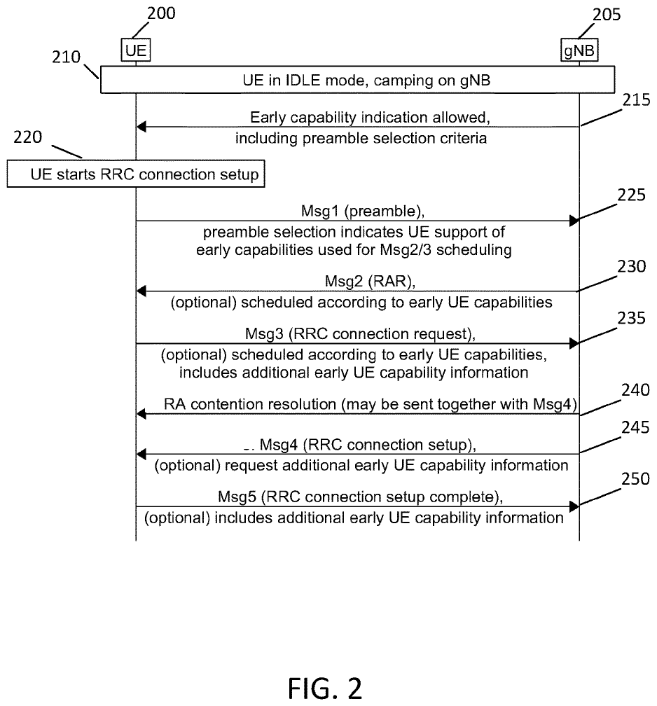

In certain example embodiments, the full early capability information may be divided between two or more messages. Carrying capability information in Msg1 may mean partitioning of the PRACH resources causing some PRACH capacity loss. To avoid excess PRACH partitioning, certain example embodiments may carry the capability information in a hierarchical manner. For instance, basic information, relevant for Msg2/3 scheduling, may be carried with Msg1, and more detailed information may be carried in Msg3/5. FIG. 2 illustrates an example signal diagram, according to certain example embodiments. In particular, FIG. 2 illustrates an example of the hierarchal manner in which the capability information may be carried with Msg1 and more detailed information in Msg3/5.

As illustrated in FIG. 2, at 210, the UE 200 may be in IDLE mode, camping on the gNB 205. At 215, the gNB 205 may transmit an indication to the UE 200 informing the UE 200 that early capability indication is allowed, optionally including preamble selection criteria for carrying information of capabilities supported by the UE via Msg1. At 220, the UE 200 may start RRC connection setup to connect to the network. At 225, the UE 200 may select a Msg1 preamble from a preconfigured Msg1 preamble set to indicate if it supports early capabilities that gNB may take into account for Msg2/3 scheduling. As discussed herein, Msg1 may indicate an early UE capability information, and Msg3/5 may indicate more (i.e., additional) early UE capability information, and Msg2/4 may further configure or request which information is provided in Msg5.

At 230, the gNB 205 may transmit Msg2 (RAR) to the UE 200. In some example embodiments, Msg2 may be transmitted based on scheduling according to the early UE capabilities received in Msg1. In some example embodiments, Msg2 may include a request of additional early UE capability information in one or more subsequent messages. At 235, the UE 200 may transmit Msg3 (RRC connection request) to the gNB 205. According to some example embodiments, Msg3 may include additional early UE capability information, and may be scheduled according to the early UE capabilities received in Msg1. At 240, the gNB 205 may transmit a RA contention resolution message to the UE 200. In some example embodiments, the RA contention resolution may be transmitted to the UE 200 via Msg4 when Msg4 is transmitted by the gNB 205 to the UE 200 at 245. Msg4 may correspond to an RRC connection setup with the UE 200, and may include request of additional early UE capability information. At 250, the UE 200 may transmit Msg5 to the gNB 205, where Msg5 may indicate that the RRC connection setup between the UE 200 and the gNB 205 has been completed. In some example embodiments, Msg5 may also include additional early UE capability information.

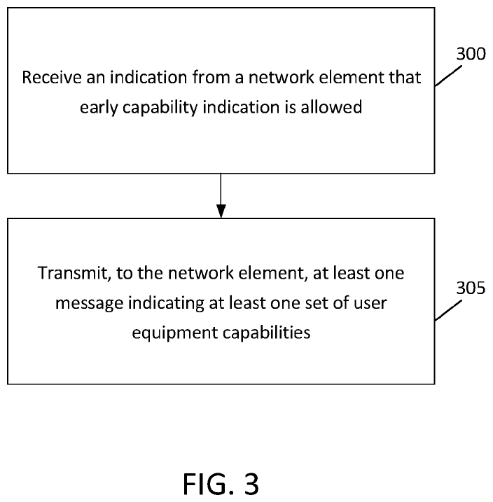

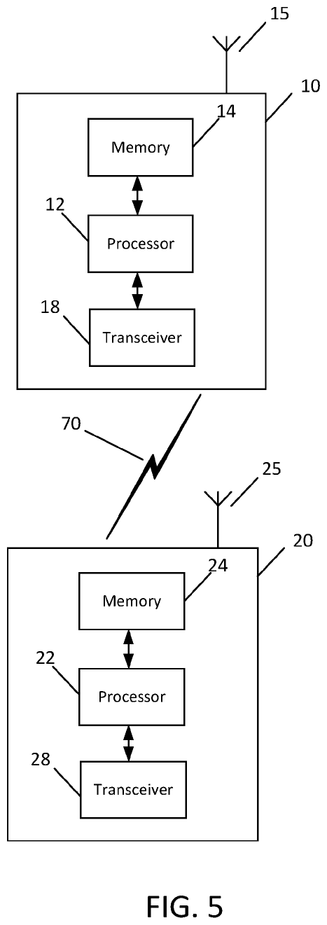

FIG. 3 illustrates an example flow diagram of a method, according to certain example embodiments. In an example embodiment, the method of FIG. 3 may be performed by a network entity, or a group of multiple network elements for example in a 3GPP system, such as LTE or 5G-NR. For instance, in an example embodiment, the method of FIG. 3 may be performed by a UE similar to one of apparatuses 10 or 20 illustrated in FIG. 5.

According to certain example embodiments, the method of FIG. 3 may include, at 300, receiving an indication from a network element that early capability indication is allowed. The method may also include, at 305, transmitting, to the network element, at least one message indicating at least one set of UE capabilities.

According to certain example embodiments, the indication comprises at least one of preamble selection criteria, or information regarding allowed UE capabilities for early indication. According to some example embodiments, the at least one set of UE capabilities may include a first set of UE capabilities. The first set of UE capabilities may include at least one of support for communication on a frequency range when there is an initial access on another frequency range, support for specific configuration for at least one of physical uplink control channel, physical uplink shared channel, physical downlink control channel, or physical downlink shared channel, or support of enhanced UE capability indication. According to other example embodiments, the at least one message may include a first message, and the method may also include receiving, from the network element, a second message. The second message may be received according to capabilities contained in the first message.

In certain example embodiments, the second message may include a request for UE capability information, the at least one message may include a third message, the at least one set of UE capabilities comprises a second set of UE capabilities, and the third message may include an indication of the second set of UE capabilities. In some example embodiments, the first message may include a preamble selection indicating support of early capabilities for the network element to schedule at least one subsequent message. In other example embodiments, the third message may include a RRC connection request. In further example embodiments, the method may also include receiving, from the network element, a fourth message to setup a radio resource control connection.

According to certain example embodiments, the fourth message may include a request for UE capability information, the at least one message comprises a fifth message, the at least one set of UE capabilities may include a third set of UE capabilities, and the fifth message may include an indication of the third set of UE capabilities. The method may further include, in response to the fourth message, completing radio resource connection setup with the network element.

According to some example embodiments, the first message may include a RRC connection request. According to other example embodiments, the second message may be to setup a RRC connection. In response to the second message, the method may further include completing radio resource connection setup with the network element.

In certain example embodiments, the at least one set of UE capabilities may be indicated by at least one of a bitmap indicating applicable basic capabilities, a bitmap indicating applicable capability sets, or an identifier of the second set of UE capabilities. In other example embodiments, the at least one set of UE capabilities may include a combination of capabilities from another set of UE capabilities and additional UE capabilities.

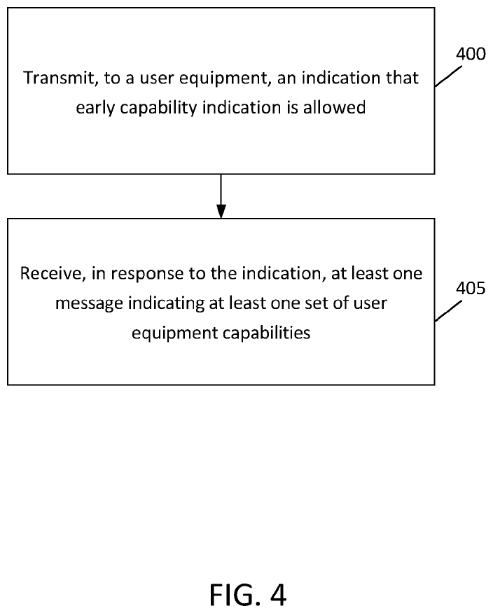

FIG. 4 illustrates an example flow diagram of a method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by a gNB similar to one of apparatuses 10 or 20 illustrated in FIG. 5.

According to certain example embodiments, the method of FIG. 4 may include, at 400, transmitting, to a UE, an indication that early capability indication is allowed. The method may also include, at 405, receiving, in response to the indication, at least one message indicating at least one set of UE capabilities.

According to certain example embodiments, the indication comprises at least one of preamble selection criteria, or information regarding allowed UE capabilities for early indication. According to some example embodiments, the at least one set of UE capabilities may include a first set of UE capabilities. The first set of UE capabilities may include at least one of support for communication on a frequency range when there is an initial access on another frequency range, support for specific configuration for at least one of physical uplink control channel, physical uplink shared channel, physical downlink control channel, or physical downlink shared channel, or support of enhanced UE capability indication. According to other example embodiments, the at least one message may include a first message, and the method may further include transmitting, to the UE, a second message. According to further example embodiments, the second message may be transmitted according to capabilities contained in a first message.

In certain example embodiments, the second message may include a request for UE capability information, the at least one message may include a third message, the at least one set of UE capabilities comprises a second set of UE capabilities, and the third message may include an indication of the second set of UE capabilities. In some example embodiments, the first message may include a preamble selection indicating support of early capabilities for the network element to schedule at least one subsequent message. In other example embodiments, the third message may include a RRC connection request. In further example embodiments, the method may also include transmitting, to the UE, a fourth message to setup a RRC connection.

According to certain example embodiments, the fourth message may include a request for UE capability information, the at least one message may include a fifth message, the at least one set of UE capabilities may include a third set of UE capabilities, and the fifth message may include an indication of the third set of UE capabilities. According to other example embodiments, the method may also include completing a radio resource connection setup with the UE.

According to further example embodiments the first message may include a RRC connection request. In certain example embodiments, the second message may be to setup a RRC connection, and the method may further include completing radio resource connection setup with the UE.

In some example embodiments, the at least one set of UE capabilities may be indicated by at least one of a bitmap indicating applicable basic capabilities, a bitmap indicating applicable capability sets, or an identifier of the second set of UE capabilities. In other example embodiments, the at least one set of UE capabilities may include a combination of capabilities from another set of UE capabilities and additional UE capabilities.

FIG. 5 illustrates a set of apparatuses 10 and 20 according to certain example embodiments. In certain example embodiments, the apparatus 10 may be an element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 5.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 5.

As illustrated in the example of FIG. 5, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 5, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 1-3.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 1-3.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive an indication from a network element that early capability indication is allowed. Apparatus 10 may also be controlled by memory 14 and processor 12 to transmit, to the network element, at least one message indicating at least one set of user equipment capabilities.

As illustrated in the example of FIG. 5, apparatus 20 may be a network, core network element, or element in a communications network or associated with such a network, such as a gNB, BS, cell, or NW. It should be noted that one of ordinary skill in the art would understand that apparatus 20 may include components or features not shown in FIG. 5.

In some example embodiments, apparatus 20 may include one or more processors, one or more computer-readable storage medium (for example, memory, storage, or the like), one or more radio access components (for example, a modem, a transceiver, or the like), and/or a user interface. In some example embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 5.

As illustrated in the example of FIG. 5, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes and examples illustrated in FIGS. 1, 2, and 4.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods and examples illustrated in FIGS. 1, 2, and 4.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to transmit, to a UE, an indication that early capability indication is allowed. Apparatus 20 may also be controlled by memory 24 and processor 22 to receive, in response to the indication, at least one message indicating at least one set of user equipment capabilities.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for receiving an indication from a network element that early capability indication is allowed. The apparatus may also include means for transmitting, to the network element, at least one message indicating at least one set of user equipment capabilities.

Other example embodiments may be directed to an apparatus that includes means for transmitting, to a UE, an indication that early capability indication is allowed. The apparatus may also include means for receiving, in response to the indication, at least one message indicating at least one set of user equipment capabilities.

Certain example embodiments described herein provide several technical improvements, enhancements, and/or advantages. For instance, in some example embodiments, it may be possible to allow the network to immediately create a configuration that allows better UP connectivity without waiting for full capability signaling. It may also be possible to allow for better scheduling of a first RRCReconfiguration that sets up the DRBs, and avoid excess PRACH partitioning. In other example embodiments, it may be possible to avoid security issues where fake UEs impersonate other UEs, and avoid UEs attaching to fake gNBs that are there to provide access after the legitimate gNB access has been blocked.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GCN 5G Core Network
5GS 5G System
AMF Access and Mobility Function
AS Access Stratum
BS Base Station
BWP Bandwidth Part
CU Centralized Unit
DDoS Distributed DoS
DL Downlink
DoS Denial-of-Service
DU Distributed Unit
eNB Enhanced Node B
E-UTRAN Evolved UTRAN
gNB 5G or Next Generation NodeB
IMSI International Mobile Subscriber Identity
LCID Logical Channel Identity
LTE Long Term Evolution
MAC Medium Access Control
MitM Man-in-the-Middle
Msg Message
NAS Non-Access Stratum
NR New Radio
NW Network
PDoS Permanent DoS
PRACH Physical RACH
PUCCH Physical Uplink Control Channel
PUSCH Physical Uplink Shared Channel
RACH Random Access Channel
RAN Radio Access Network
RAT Radio Access Technology
RRC Radio Resource Control
Rx Reception
SI System Information
SIB System Information Block
SDT Small Data Transmission
S-TMSI Serving Temporary Mobile Subscriber Identity
Tx Transmission
UE User Equipment
UL Uplink
UP User Plane

(1-80) canceled

81. A method, comprising:
receiving an indication from a network element that early capability indication is allowed, and
transmitting, to the network element, at least one message indicating at least one set of user equipment capabilities.

82. An apparatus, comprising:
at least one processor; and
at least one memory storing instructions that,
when executed by the at least one processor, cause the apparatus at least to:
receive an indication from a network element that early capability indication is allowed, and
transmit, to the network element, at least one message indicating at least one set of user equipment capabilities.

83. The apparatus according to claim 82, wherein the indication comprises at least one of the following:
preamble selection criteria, or
information regarding allowed user equipment capabilities for early indication.

84. The apparatus according to claim 82, wherein the at least one set of user equipment capabilities comprises a first set of user equipment capabilities, and the first set of user equipment capabilities comprises at least one of the following:
support for communication on a frequency range when there is an initial access on another frequency range,
support for specific configuration for at least one of physical uplink control channel, physical uplink shared channel, physical downlink control channel, or physical downlink shared channel, or
support of enhanced user equipment capability indication.

85. The apparatus according to claim 82, wherein the at least one message comprises a first message, and the apparatus is further caused to:
receive, from the network element, a second message,
wherein the second message is received according to capabilities contained in the first message.

86. The apparatus according to claim 85, wherein the second message comprises a request for user equipment capability information, the at least one message comprises a third message, the at least one set of user equipment capabilities comprises a second set of user equipment capabilities, and the third message comprises an indication of the second set of user equipment capabilities.

87. The apparatus according to claim 85, wherein the first message comprises a preamble selection indicating support of early capabilities for the network element to schedule at least one subsequent message.

88. The apparatus according to claim 86, wherein the third message comprises a radio resource control connection request.

89. The apparatus according to claim 87, wherein the apparatus is further caused to:
receive, from the network element, a fourth message to setup a radio resource control connection.

90. The apparatus according to claim 89,
wherein the fourth message comprises a request for user equipment capability information, the at least one message comprises a fifth message, the at least one set of user equipment capabilities comprises a third set of user equipment capabilities, and the fifth message comprises an indication of the third set of user equipment capabilities, and
wherein the apparatus is further caused to, in response to the fourth message, complete radio resource connection setup with the network element.

91. The apparatus according to claim 85, wherein the first message comprises a radio resource control connection request.

92. The apparatus according to claim 91,
wherein the second message is to setup a radio resource control connection, and
wherein the apparatus is further caused to, in response to the second message, complete radio resource connection setup with the network element.

93. The apparatus according to claim 82, wherein the at least one set of user equipment capabilities is indicated by at least one of the following:
a bitmap indicating applicable basic capabilities,
a bitmap indicating applicable capability sets, or
an identifier of the second set of user equipment capabilities.

94. The apparatus according to claim 82, wherein the at least one set of user equipment capabilities comprises a combination of capabilities from another set of user equipment capabilities and additional user equipment capabilities.

95. An apparatus, comprising:
at least one processor; and
at least one memory storing instructions that,
when executed by the at least one processor, cause the apparatus at least to:
transmit, to a user equipment, an indication that early capability indication is allowed; and
receive, in response to the indication, at least one message indicating at least one set of user equipment capabilities.

96. The apparatus according to claim 95, wherein the indication comprises at least one of the following:
preamble selection criteria, or
information regarding allowed user equipment capabilities for early indication.

97. The apparatus according to claim 95, wherein the at least one set of user equipment capabilities comprises a first set of user equipment capabilities, and the first set of user equipment capabilities comprises at least one of the following:
support for communication on a frequency range when there is an initial access on another frequency range,
support for specific configuration for at least one of physical uplink control channel, physical uplink shared channel, physical downlink control channel, or physical downlink shared channel, or
support of enhanced user equipment capability indication.

98. The apparatus according to claim 95, wherein the at least one message comprises a first message, and the apparatus is further caused to:
transmit, to the user equipment, a second message,
wherein the second message is transmitted according to capabilities contained in a first message.

99. The apparatus according to claim 98, wherein the second message comprises a request for user equipment capability information, the at least one message comprises a third message, the at least one set of user equipment capabilities comprises a second set of user equipment capabilities, and the third message comprises an indication of the second set of user equipment capabilities.

100. The apparatus according to claim 98, wherein the first message comprises a preamble selection indicating support of early capabilities for the network element to schedule at least one subsequent message.
